(19) United States
(12) Patent Application Publication
(10) Pub. No.: US 2024/0391741 A1
(43) Pub. Date: Nov. 28, 2024

(54) STAND-ALONE ELECTRONIC CONTROL OF WINCHES

(71) Applicant: PACCAR Inc, Bellevue, WA (US)

(72) Inventors: Jesse Cameron Teahon, Stillwater, OK (US); Floyd James Hendrix, Coweta, OK (US); Christopher Shahram Etemadi, Tulsa, OK (US); Donald Christopher Carl, Bixby, OK (US)

(21) Appl. No.: 18/694,700

(22) PCT Filed: Sep. 24, 2021
(86) PCT No.: PCT/US2021/052039

§ 371 Date: Mar. 22, 2024

(51) Int. Cl. B66D 1/46; B66D 1/44; E02F 9/20; E02F 9/22

(52) U.S. Cl. CPC B66D 1/46; B66D 1/44; E02F 9/2016; E02F 9/22

(57) ABSTRACT

A piece of heavy construction or forestry equipment includes an internal combustion engine configured to generate power from combustion of fuel, a winch coupled to the internal combustion engine such that power generated by the internal combustion engine is transmitted to the winch by a non-mechanical connection, a first electronic control unit, wherein the first electronic control unit is configured to control operation of components of the piece of heavy construction equipment other than the winch, and a second electronic control unit, wherein the second electronic control unit is independent of the first electronic control unit and configured to control operation of the winch.

### BACKGROUND

### Technical Field

The present disclosure relates generally to mobile construction, forestry, service, and agricultural equipment (including track-type or wheeled machinery, construction equipment, or vehicles, including tractors, skidders, bulldozers, loaders, graders, backhoes, harvesters, feller-bunchers, forwarders, and on-road or off-road trucks), which include winches controlled by stand-alone electronic control systems.

### Description of the Related Art

Heavy equipment, such as track-type or wheeled machinery, construction equipment, or vehicles, including tractors, skidders, bulldozers, loaders, graders, backhoes, harvesters, feller-bunchers, forwarders, and on-road or off-road trucks, often comprises mechanical, hydraulic, and/or electronic systems for driving various subsystems, attachments, or components thereof, including winches. Hydraulic systems typically include a tank or reservoir of hydraulic fluid, a hydraulic pump, and a valve stack including a plurality of control valves for controlling the flow of the hydraulic fluid between the reservoir, the pump, and/or the hydraulically-powered components. Traditionally, such valve stacks included a plurality of valves, with each of the valves selected or optimized for use with the specific hydraulically-powered components to which it was coupled, and to which it controlled the flow of the hydraulic fluid.

FIG. 1 illustrates one example of a hydraulic system including a tank of hydraulic fluid, a pump, a single-acting hydraulic cylinder, a double acting hydraulic cylinder, a unidirectional hydraulic motor, a bi-directional hydraulic motor, and a stack valve (or “valve stack”) that includes a plurality of individual hydraulic control valves (or “valve sections”) that are packaged together in a single housing with common connections to the hydraulic pump and tank.

FIG. 2 illustrates another example of a hydraulic system that is similar to the hydraulic system of FIG. 1, except that it includes four separately-housed hydraulic control valves rather than four valve sections within a single housing. The particular hydraulic actuators illustrated in the work loops of both FIG. 1 and FIG. 2 (single-acting cylinder, double-acting cylinder, unidirectional motor, and bi-directional motor) are examples only, and real-world hydraulic systems may have any number of work loops (more or less than the four shown) and may have any combination of hydraulic actuator types (not necessarily limited to the four types shown in the illustrations).

FIG. 3 illustrates an example of a hydraulic system including a winch, a tank of hydraulic fluid, a hydraulic work loop, a hydraulic pump, which may be a variable displacement hydraulic pump and may be driven by mechanical power to pump hydraulic fluid around the hydraulic work loop, and a hydraulic motor, which may be a bi-directional variable or fixed displacement hydraulic motor and may be driven by hydraulic fluid flowing from the pump, around the hydraulic work loop through the hydraulic motor, and back to the hydraulic pump, to drive operation of the winch.

FIG. 4 illustrates an example of an electric system driven directly by an internal combustion engine of the piece of heavy equipment. For example, FIG. 4 illustrates that a mechanical drive powered by the internal combustion engine can power an electric generator, that generated electric power can be communicated from the generator, through a set of controls, to an electric motor, and that the electric motor can drive operation of a winch.

FIG. 5 illustrates an example of a hybrid-electric system driven directly by an internal combustion engine of the piece of heavy equipment. For example, FIG. 5 illustrates that a mechanical drive powered by the internal combustion engine can power an electric generator, that generated electric power can be communicated from the generator, through a set of controls, to an electric motor, and that the electric motor can drive operation of a winch. FIG. 5 further illustrates that the system can include an energy storage device. In use, the controls can route electrical energy from the generator to the energy storage device when more electrical energy is provided by the generator than is demanded by the motor. Additionally, the controls can route electrical energy from the motor to the energy storage device if the motor is used in reverse to recover energy from the winch. Furthermore, the controls can route electrical energy from the energy storage device to the motor when less electrical energy is provided by the generator than is demanded by the motor.

FIG. 6 illustrates an example of an electric system driven directly by a fuel cell system of the piece of heavy equipment. For example, FIG. 6 illustrates that generated electric power can be communicated from the fuel cell, through a set of controls, to an electric motor, and that the electric motor can drive operation of a winch. FIG. 6 further illustrates that the system can include an energy storage device. In use, the controls can route electrical energy from the fuel cell system to the energy storage device when more electrical energy is provided by the fuel cell system than is demanded by the motor. Additionally, the controls can route electrical energy from the motor to the energy storage device if the motor is used in reverse to recover energy from the winch. Furthermore, the controls can route electrical energy from the energy storage device to the motor when less electrical energy is provided by the fuel cell system than is demanded by the motor.

FIG. 7 illustrates an example of an electric system driven directly by a battery of the piece of heavy equipment (a “pure electric” system or a “battery-electric” system). For example, FIG. 7 illustrates that electric power can be communicated from the battery, which operates as an energy storage device, through a set of controls, to an electric motor, and that the electric motor can drive operation of a winch. In use, the controls can route electrical energy from the motor to the battery if the motor is used in reverse to recover energy from the winch.

FIG. 8 illustrates a perspective view of a first end 102 of a winch 100 that has a central longitudinal axis 106. FIG. 9 illustrates a perspective view of a second end 104 of the winch 100, which is opposite to the first end 102 illustrated in FIG. 8 along the central longitudinal axis 106. FIG. 1 illustrates that the winch 100 includes a first mounting flange 108 at its first end 102, which is oriented perpendicular to the central longitudinal axis 106 and includes a plurality of holes or apertures extending therethrough along respective axes parallel to the central longitudinal axis 106. In use, the winch 100 can be mounted to another piece of machinery by mechanical fasteners such as bolts or screws that extend through the apertures in the first mounting flange 108 and through corresponding apertures in a mounting flange of the other piece of machinery. When the winch 100 is mounted to another piece of machinery in this way, the mounting first flange 108 is rigidly coupled to the other piece of machinery and remains stationary with respect to the other piece of machinery during use.

FIG. 9 illustrates that the winch 100 also includes a second mounting flange 110 at its second end 104, which is oriented perpendicular to the central longitudinal axis 106 and parallel to the first mounting flange 108, and includes a plurality of holes or apertures extending therethrough along respective axes parallel to the central longitudinal axis 106. In use, the winch 100 can be mounted to the other piece of machinery by mechanical fasteners such as bolts or screws that extend through the apertures in the second mounting flange 110 and through corresponding apertures in a mounting flange of the other piece of machinery. When the winch 100 is mounted to another piece of machinery in this way, the second mounting flange 110 is rigidly coupled to the other piece of machinery and remains stationary with respect to the other piece of machinery during use.

FIGS. 8 and 9 illustrate that the winch 100 includes a spool or drum 112 that is rotatable about the central longitudinal axis 106 with respect to the mounting flanges 108 and 110. In use, a cable, rope, wire, or chain having a first end and a second end opposite the first end may be fastened at the first end thereof to the drum 112. The cable may be wound up about the drum 112, and the second end of the cable may be coupled to a load to be pulled by the winch 100. The winch 100 can be operated to drive rotation of the drum 112 about the central longitudinal axis 106 with respect to the mounting flanges 108 and 110 and with respect to the piece of machinery to which the winch 100 is mounted, such as to wind up the cable onto the drum 112 to pull the load toward the winch 100.

### BRIEF SUMMARY

A piece of heavy construction or forestry equipment may be summarized as comprising: an internal combustion engine configured to generate power from combustion of fuel; a winch coupled to the internal combustion engine such that power generated by the internal combustion engine is transmitted to the winch by a non-mechanical connection; a first electronic control unit, wherein the first electronic control unit is configured to control operation of components of the piece of equipment other than the winch; and a second electronic control unit, wherein the second electronic control unit is independent of the first electronic control unit and configured to control operation of the winch.

The non-mechanical connection may be a hydraulic connection. The winch may be powered by an open-loop hydraulic system or a closed-loop hydraulic system. The non-mechanical connection may be an electric connection. The first electronic control unit may be configured to control operation of at least one of: a steering component of the piece of equipment; an operative end-effector of the piece of equipment, a ripper, a movable boom, a movable blade, a grapple, a pipelayer drawworks, a wheel drive, a track drive, a swing drive, a chipper, a tiller, a grinder, a sweeper, a hoist, a capstan, and a fan. The second electronic control unit may include a programmable logic controller.

A piece of heavy construction or forestry equipment may be summarized as comprising: a source of electrical power; a winch coupled to the source of electrical power; a first electronic control unit, wherein the first electronic control unit is configured to control operation of components of the piece of equipment other than the winch; and a second electronic control unit, wherein the second electronic control unit is independent of the first electronic control unit and configured to control operation of the winch.

The first electronic control unit may be configured to control operation of at least one of: a steering component of the piece of equipment; an operative end-effector of the piece of equipment, a ripper, a movable boom, a movable blade, a grapple, a pipelayer drawworks, a wheel drive, a track drive, a swing drive, a chipper, a tiller, a grinder, a sweeper, a hoist, a capstan, and a fan. The second electronic control unit may include a programmable logic controller.

A method of operating a piece of heavy construction or forestry equipment may be summarized as comprising: running an internal combustion engine, thereby generating power from combustion of fuel; transmitting power generated by the internal combustion engine to a winch by a non-mechanical connection; controlling operation of components of the piece of heavy construction or forestry equipment other than the winch using a first electronic control unit; and controlling operation of the winch using a second electronic control unit independent of the first electronic control unit.

The method may further comprise: storing information regarding operation of the winch in the second electronic control unit; using the information stored in the second electronic control unit to detect an undesired condition of the operation of the winch; and upon detecting the undesired condition of the operation of the winch, generating an alarm indicating the detection of the undesired condition. The method may further comprise: storing information regarding operation of the winch in the second electronic control unit; and using the information stored in the second electronic control unit to control operation of the winch. The internal combustion engine may be a diesel engine and the fuel may be diesel. The non-mechanical connection may interrupt mechanical transmission of power from the internal combustion engine to the winch.

A method of operating a piece of heavy construction or forestry equipment may be summarized as comprising: transmitting electrical power from a source of electrical power to a winch; controlling operation of components of the piece of heavy construction or forestry equipment other than the winch using a first electronic control unit; and controlling operation of the winch using a second electronic control unit independent of the first electronic control unit.

The method may further comprise: storing information regarding operation of the winch in the second electronic control unit; using the information stored in the second electronic control unit to detect an undesired condition of the operation of the winch; and upon detecting the undesired condition of the operation of the winch, generating an alarm indicating the detection of the undesired condition. The method may further comprise: storing information regarding operation of the winch in the second electronic control unit; and using the information stored in the second electronic control unit to control operation of the winch.

### BRIEF DESCRIPTION OF THE SEVERAL VIEWS OF THE DRAWINGS

FIG. 1 illustrates a schematic diagram of a hydraulic system.

FIG. 2 illustrates a schematic diagram of another hydraulic system.

FIG. 3 illustrates a schematic diagram of another hydraulic system.

FIG. 4 illustrates a schematic diagram of an electric system driven directly by an internal combustion engine.

FIG. 5 illustrates a schematic diagram of a hybrid-electric system driven directly by an internal combustion engine.

FIG. 6 illustrates a schematic diagram of an electric system driven directly by a fuel cell system.

FIG. 7 illustrates a schematic diagram of a battery electric system.

FIG. 8 illustrates a perspective view of a winch.

FIG. 9 illustrates another perspective view of the winch of FIG. 8.

FIG. 10 illustrates a diagram showing relationships between features of a winch control system.

FIG. 11 illustrates a piece of heavy equipment.

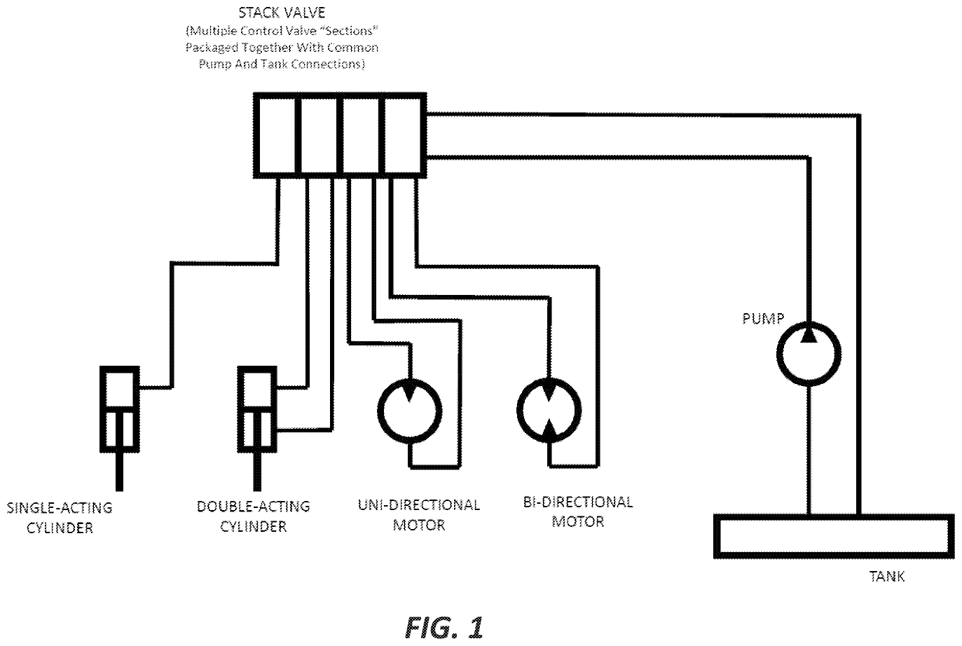

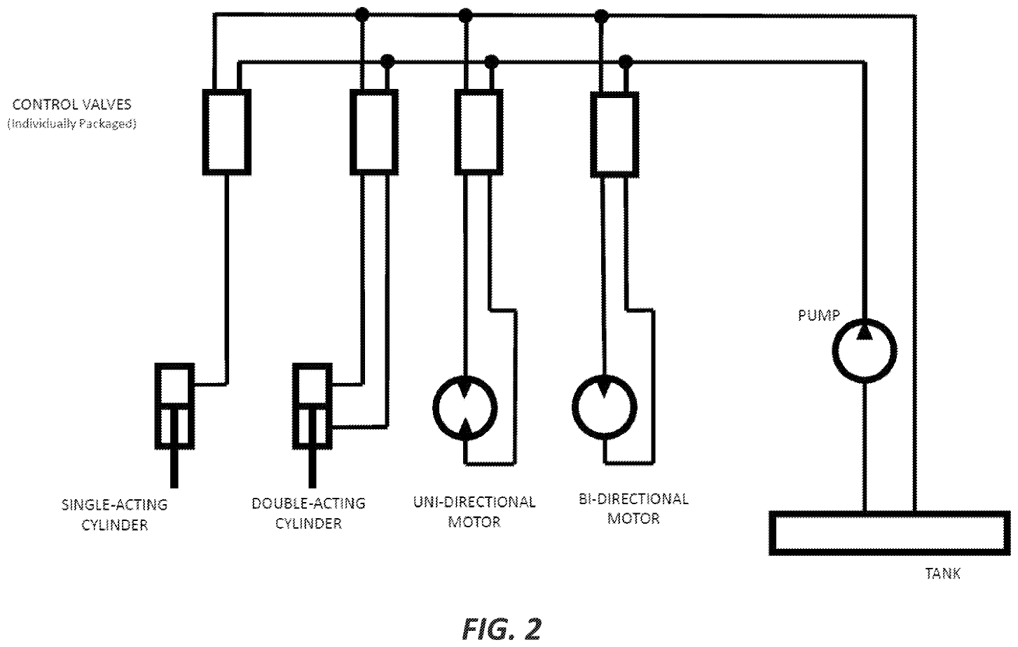

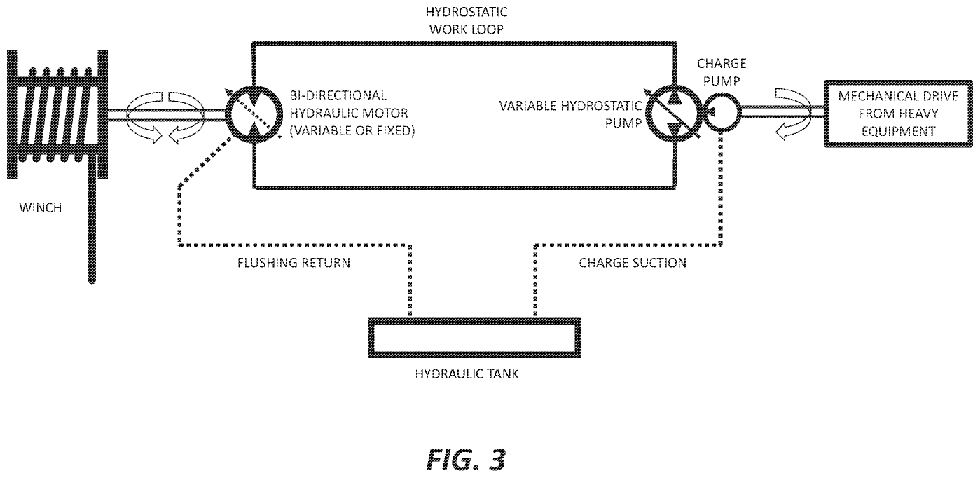

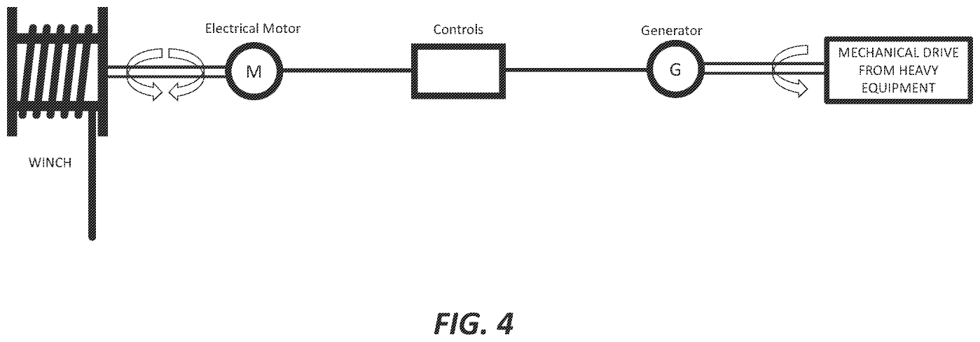

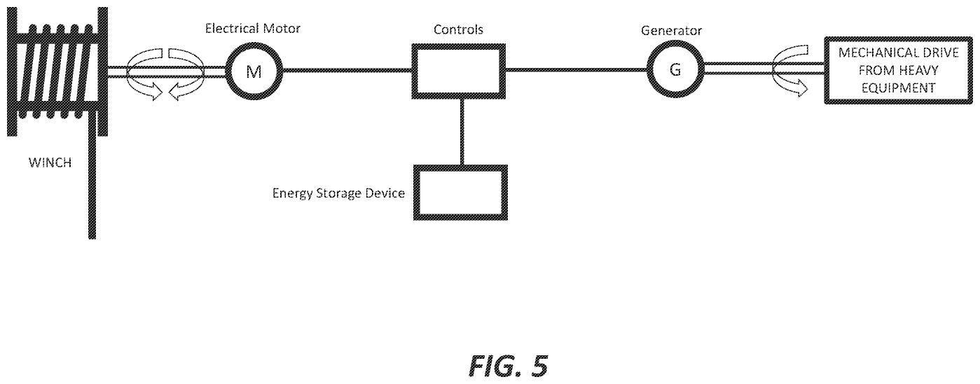

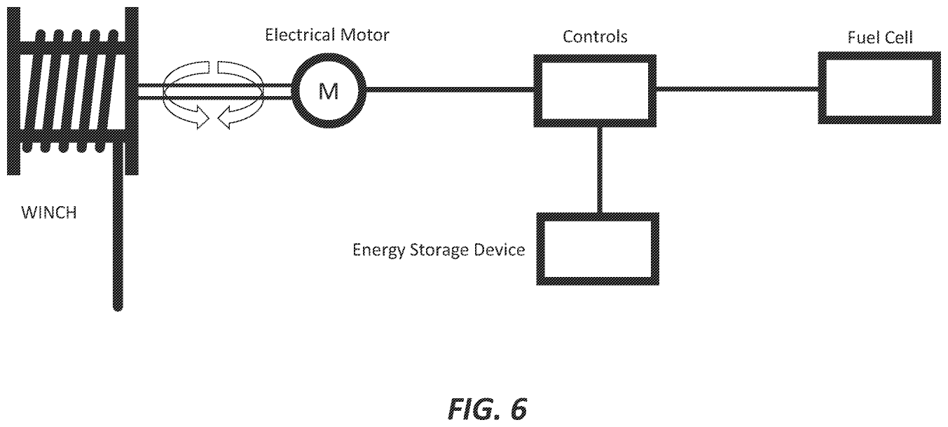

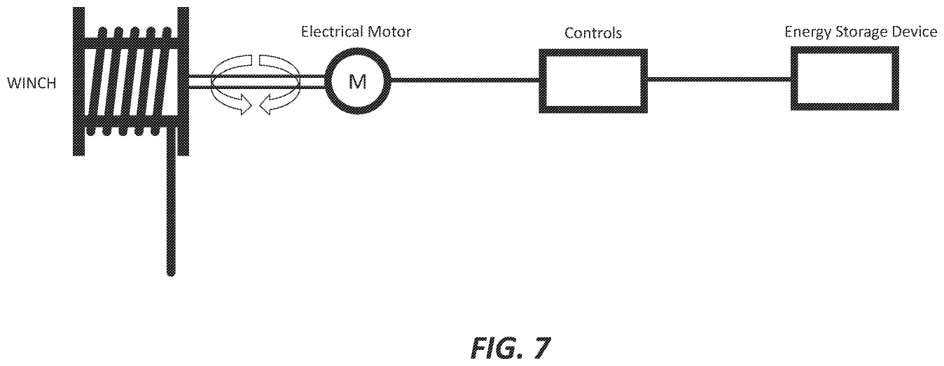

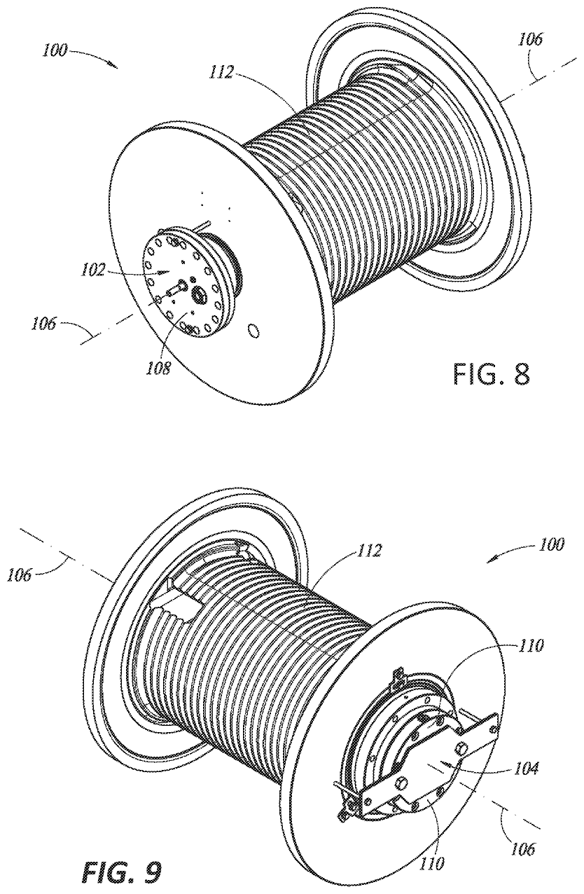

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The use of ordinals such as first, second and third does not necessarily imply a ranked sense of order, but rather may only distinguish between multiple instances of an act or structure.

Terms of geometric alignment may be used herein. Any components of the embodiments that are illustrated, described, or claimed herein as being aligned, arranged in the same direction, parallel, or having other similar geometric relationships with respect to one another have such relationships in the illustrated, described, or claimed embodiments. In alternative embodiments, however, such components can have any of the other similar geometric properties described herein indicating alignment with respect to one another. Any components of the embodiments that are illustrated, described, or claimed herein as being not aligned, arranged in different directions, not parallel, perpendicular, transverse, or having other similar geometric relationships with respect to one another, have such relationships in the illustrated, described, or claimed embodiments. In alternative embodiments, however, such components can have any of the other similar geometric properties described herein indicating non-alignment with respect to one another.

Various examples of suitable dimensions of components and other numerical values may be provided herein. In the illustrated, described, and claimed embodiments, such dimensions are accurate to within standard manufacturing tolerances unless stated otherwise. Such dimensions are examples, however, and can be modified to produce variations of the components and systems described herein. In various alternative embodiments, such dimensions and any other specific numerical values provided herein can be approximations wherein the actual numerical values can vary by up to 1, 2, 5, 10, 15 or more percent from the stated, approximate dimensions or other numerical values.

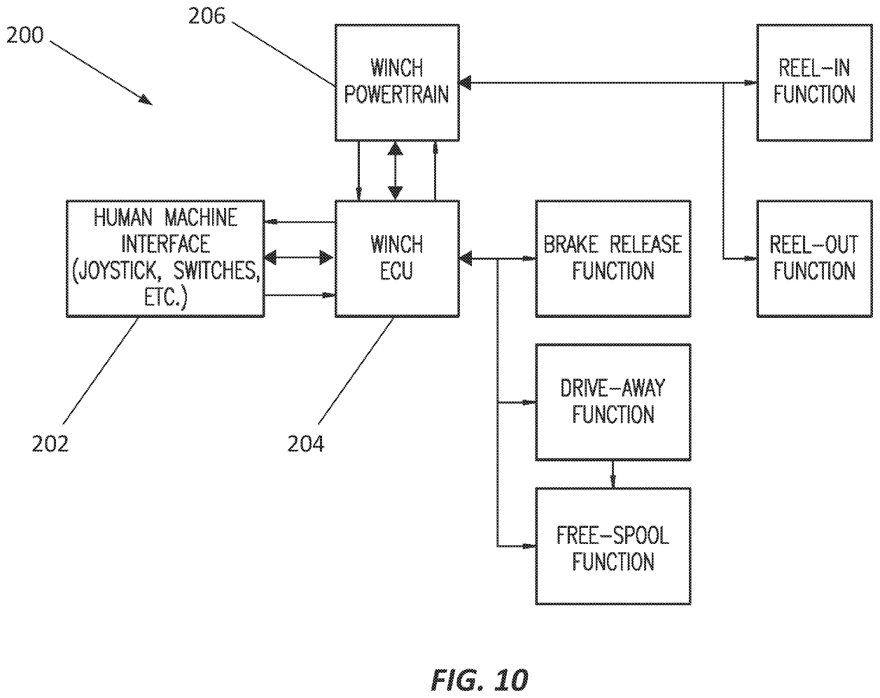

FIG. 10 illustrates a diagram showing relationships between features of a winch control system 200. As illustrated in FIG. 10, the winch control system 200 includes a human-machine interface 202, which can include any known components for receiving input from a human operator and converting such input into mechanical, electrical, and/or hydraulic signals, which may be used to control operation of a winch. Such components may include a keyboard, a mouse, a touchscreen, a microphone, a camera, a joystick, buttons, dials, and/or switches, etc. As illustrated in FIG. 10, the winch control system 200 also includes an electronic control unit (“ECU”) 204 for coordinating control of the winch based on signals received by the human-machine interface 202. In some embodiments, the electronic control unit 204 may include a microcontroller and/or a programmable logic controller (“PLC”). As used herein, the term “programmable logic controller” may include an industrial solid-state computer that monitors inputs and outputs, and makes logic-based decisions for automated processes or machines. The electronic control unit 204 may also include one or more memory-storage components, such as SRAM, EEPROM, and/or Flash devices. The electronic control unit 204 may be configured to receive input including digital and/or analog input signals, such as from the human-machine interface 202. The electronic control unit 204 may also include one or more electronic valve drivers or actuator drivers, and may be configured to provide output signals to a winch, including through the one or more electronic valve drivers or actuator drivers.

As illustrated in FIG. 10, the winch control system 200 also includes a powertrain 206 for directly supplying power to the winch based on signals received from the electronic control unit 204. The powertrain 206 may be mechanically, hydraulically, and/or electrically powered, and may convert the supplied power to mechanical power in the form of rotation of a drum of a winch. As illustrated in FIG. 10, the powertrain 206 can supply power to the winch and drive the drum of the winch to rotate, and is thereby capable of driving the winch to operate in two fundamental modes: a powered “reel-in” mode, in which the winch reels in and pulls in the cable, rope, wire, or chain wound onto its drum (spooling rope under power onto the winch drum), and a powered “reel-out” mode, in which the winch pushes out and reels out the cable, rope, wire, or chain wound onto its drum (unspooling rope under power off of the winch drum). That is, the powertrain 206 can drive the winch to operate in a first direction by providing a first torque to the drum of the winch, or can drive the winch to operate in a second direction opposite the first by providing a second torque opposite the first to the drum of the winch.

As illustrated in FIG. 10, the electronic control unit 204 can control the winch so that it has additional functionality, and/or to operate in additional modes of operation. For example, the electronic control unit 204 can control the winch to either apply or release an internal mechanical static brake within or on the winch, such as to prevent or allow, respectively, motion of a gear train and/or the drum of the winch. This can be referred to as a “brake release” function, and release of the brake may be required before other functions can be performed or other modes of operation can be engaged. For example, the brake release function may need to be performed before the winch can be used in either the “reel-in” mode or the “reel-out” mode. As another example, the electronic control unit 204 can control the winch to either engage the drum of the winch with the gear train of the winch, or to disengage the drum of the winch from the gear train of the winch while applying a braking or drag force to the drum of the winch to allow unspooling of the cable, rope, wire, or chain wound onto the drum while maintaining tension in the cable, rope, wire, or chain wound onto the drum, such as to prevent “bird-nesting” of the cable, rope, wire, or chain as it unspools, and/or to prevent inadvertent or uncontrolled unspooling of the cable, rope, wire, or chain as it unspools. This can be referred to as a “drive-away release,” “brake-off,” “drum clutch release,” or “motor bypass” mode of operation.

As another example, the electronic control unit 204 can control the winch to either engage the drum of the winch with the gear train of the winch, or to disengage the drum of the winch from the gear train of the winch without applying a braking or drag force to the drum of the winch to allow unspooling of the cable, rope, wire, or chain wound onto the drum without resistance (other than small resistances such as those resulting from friction), such as to allow the cable, rope, wire, or chain to be unwound from the drum easily (with minimal resistance). This can be referred to as a “free-spool release” mode of operation.

In some embodiments, the electronic control unit 204 can provide the winch with additional functionality and/or with additional modes of operation beyond those illustrated in FIG. 10. For example, in some embodiments, the electronic control unit 204 can control the winch to operate a variable displacement hydraulic motor thereof at its maximum displacement, such as to maintain a maximum output torque of the winch, a lowest speed of the winch, and a highest control resolution of the winch. This can be referred to as a “low lock” mode of operation. As another example, in some embodiments, the electronic control unit 204 can control the winch to operate in accordance with a variety of safety interlocks, such as to prevent the winch from operating in an unsafe manner and/or under unsafe conditions.

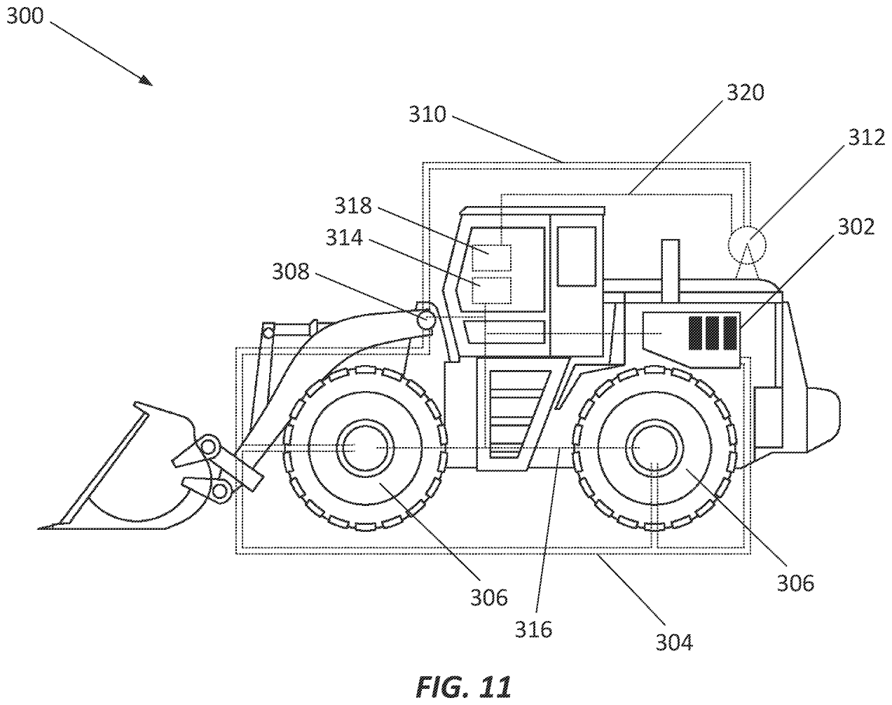

FIG. 11 illustrates a piece of heavy construction equipment 300 that includes a winch control system similar to the winch control system 200. The piece of heavy construction equipment 300 is illustrated as a wheel loader, although the piece of heavy construction equipment 300 could, in alternative embodiments, be any piece of mobile construction, forestry, service, or agricultural equipment (including track-type or wheeled machinery, construction equipment, or vehicles, including tractors, skidders, bulldozers, loaders, graders, backhoes, harvesters, feller-bunchers, forwarders, and on-road or off-road trucks). As illustrated in FIG. 11, the piece of heavy construction equipment 300 includes an internal combustion engine 302, which may be a diesel engine, that generates mechanical power from combustion of a fuel such as diesel. The mechanical power is transmitted from the internal combustion engine 302 to other components of the piece of heavy construction equipment 300 by mechanical connections 304, which may include mechanical drive shafts, etc. The mechanical connections 304 are illustrated in an abstract manner in FIG. 11 by paired dotted lines. The other components of the piece of heavy construction equipment 300 to which the mechanical connections 304 supply the mechanical power may include driving wheels 306 (or in alternative embodiments a driving track), steering components configured to steer the wheels 306 and/or the piece of heavy construction equipment 300 as it drives across a ground surface, and a hydraulic pump 308 or other hydraulic component configured to provide hydraulic power to hydraulic components of the piece of heavy construction equipment 300, such as within a closed-loop or an open-loop hydraulic system. The other components of the piece of heavy construction equipment 300 to which the mechanical connections 304 supply the mechanical power may also include operative end-effector components of the piece of heavy construction equipment 300, rippers, movable booms, movable blades, grapples, pipelayer drawworks, wheel drives, track drives, swing drives, chippers, tillers, grinders, sweepers, hoists, capstans, fans, and steering systems.

As further illustrated in FIG. 11, the piece of heavy construction equipment 300 can transmit hydraulic power from the hydraulic pump 308 to other components of the piece of heavy construction equipment 300 by hydraulic connections 310, which may include hydraulic lines or conduits carrying hydraulic fluid, etc. The hydraulic connections 310 are illustrated in an abstract manner in FIG. 11 by paired dotted lines. The other components of the piece of heavy construction equipment 300 to which the hydraulic connections 310 supply the hydraulic power may include the driving wheels 306 (or in alternative embodiments the driving track), steering components configured to steer the wheels 306 and/or the piece of heavy construction equipment 300 as it drives across a ground surface, and a winch 312 (which may include a winch powertrain having the features described herein for the winch powertrain 206) or other hydraulic components configured to provide power to the winch 312. Thus, the hydraulic connections 310 can interrupt mechanical transmission of power from the internal combustion engine 302 to the winch 312. The other components of the piece of heavy construction equipment 300 to which the hydraulic connections 310 supply the hydraulic power may also include operative end-effector components of the piece of heavy construction equipment 300, hydraulic cylinder-driven rippers, movable booms, movable blades, grapples, and steering systems, each of which may be driven by one or more hydraulic cylinders, and/or hydraulic motor-driven pipelayer drawworks, wheel drives, track drives, swing drives, chippers, tillers, grinders, sweepers, hoists, capstans, fans, and steering systems, each of which may be driven by one or more hydraulic motors.

While FIG. 11 illustrates that the piece of heavy equipment 300 includes a hydraulic pump 308 and hydraulic connections 310, in alternative implementations, such hydraulic features may be replaced by counterpart electric components, such as an electric generator and electrical wires, cables, conduits, or other similar components.

FIG. 11 also illustrates that the piece of heavy construction equipment 300 includes a first electronic control unit 314 configured to receive inputs from a human operator of the piece of heavy construction equipment 300, such as via a first human-machine interface integrated with the first electronic control unit 314, and transmit corresponding control signals to various components of the piece of heavy equipment 300. Such components may include the internal combustion engine 302, the driving wheels 306 (or in alternative embodiments the driving track), steering components configured to steer the wheels 306 and/or the piece of heavy construction equipment 300 as it drives across a ground surface, and the hydraulic pump 308 or other hydraulic components configured to provide hydraulic power to hydraulic components of the piece of heavy construction equipment 300. Such components may also include operative end-effector components of the piece of heavy construction equipment 300, rippers, movable booms, movable blades, grapples, pipelayer drawworks, wheel drives, track drives, swing drives, chippers, tillers, grinders, sweepers, hoists, capstans, fans, and steering systems. Such components may not include the winch 312.

The first electronic control unit 314 may transmit such corresponding control signals to such components via a first wired or wireless communications network 316, which may include any one of various industry-accepted networking systems using any generally accepted networking communications protocol. For example, the first communications network 316 may use and operate in accordance with Society of Automotive Engineers standard SAE J1939. The first wired or wireless communications network 316 is illustrated in an abstract manner in FIG. 11 by single dotted lines.

FIG. 11 also illustrates that the piece of heavy construction equipment 300 includes a second electronic control unit 318 configured to receive inputs from a human operator of the piece of heavy construction equipment 300, such as via a second human-machine interface integrated with the second electronic control unit 318, and transmit corresponding control signals to the winch 312. Thus, the winch 312 is provided with a dedicated, stand-alone second electronic control unit 318, which is independent of the first electronic control unit 314. For example, there may be no electrical, electronic, or other signal-carrying wired or wireless connection between the first electrical control unit 314 and the second electrical control unit 318.

In some embodiments, information regarding operation of the winch (or “winch parameters”) can be stored in the second electronic control unit 318. In some embodiments, such information may include data provided by one or more pressure, speed, temperature, or strain gauges or any other suitable sensor, and may be useful in determining safety, operability, condition, and/or durability of one or more parts of the winch. Such information stored in the second electronic control unit 318 can be used to detect an undesired condition of the operation of the winch 312. Upon detecting the undesired condition of the operation of the winch 312, a service code and/or an alarm can be generated to indicate the detection of the undesired condition. Such service codes and/or alarms can include failure and/or overload alarms and/or failure event “freeze frames” useful in troubleshooting malfunctions. In some embodiments, upon detection of an undesired condition, a correctable action can be suggested and/or taken to address or correct the undesired condition.

In some embodiments, information regarding operation of the winch (or “winch parameters”) can be stored in the second electronic control unit 318. In some embodiments, such information may include data provided by various sensors including transducers, encoders, proximity sensors, load cells, etc. Such information stored in the second electronic control unit 318 or signals carrying such information can be used to provide brake release timing, and/or to prevent/block, delay, sequence, and/or actuate any one of the functions of the winch 312, such as the winch functions or modes of operation described herein, and/or any other primary or secondary winch functions or modes of operation known in the art. Thus, the winch 312 can include a variety of sensors that output signals carrying information, and such information can be actively used by the second electronic control unit to modify or otherwise control operation of the winch 312.

The second electronic control unit 318 may transmit control signals to the winch 312 via a second wired or wireless communications network 320, which may include any one of various industry-accepted networking systems using any generally accepted networking communications protocol. For example, the second communications network 320 may use and operate in accordance with Society of Automotive Engineers standard SAE J1939. The second wired or wireless communications network 320 is illustrated in an abstract manner in FIG. 11 by single dotted lines. There may be no electrical, electronic, or other signal-carrying wired or wireless connection between the first communications network 316 and the second communications network 320. Thus, the first electronic control unit 314 and the first communications network 316 may be electrically, electronically, and/or communicatively disconnected from or unconnected to the second electronic control unit 318 and the second communications network 320.

The second electronic control unit 318, the second communications network 320, and the winch 312 may include components and functionality matching that described herein for the winch control system 200. Further, these components are configured to provide all of the features, functionality, and modes of operation described herein with respect to the winch control system 200. In particular, the second electronic control unit 318 is configured to receive inputs from a human operator indicating that the human operator would like the winch to perform any of the operations described herein or operate in any of the modes of operation described herein, and generate and transmit corresponding output signals through the second communications network 320 to the winch 312. The second communications network 320 is configured to carry such signals from the second electronic control unit 318 to the winch 312. The winch 312 is configured to receive such signals and perform the desired operations and/or perform in the desired mode of operation.

A winch system including the second electronic control unit 318, the second human-machine interface integrated with the second electronic control unit 318, the second communications network 320, and the winch 312, including the winch powertrain thereof, may be retrofittable onto a wide variety of different pieces of equipment or machinery, including mobile construction, forestry, service, and agricultural equipment (including track-type or wheeled machinery, construction equipment, or vehicles, including tractors, skidders, bulldozers, loaders, graders, backhoes, harvesters, feller-bunchers, forwarders, and on-road or off-road trucks). Thus, due to this wide-ranging compatibility, a single winch system may be usable with a much wider array of equipment or machinery than before. Furthermore, such a winch system can be developed and updated independently of the equipment or machinery onto which it will be or is intended to be installed or retrofitted. Thus, where a manufacturer of the equipment or machinery is a different entity than a manufacturer of the winch system, each manufacturer can design and optimize its own products without compromising compatibility with the other's products.

Aspects of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A piece of heavy construction or forestry equipment, comprising:
an internal combustion engine configured to generate power from combustion of fuel;
a winch coupled to the internal combustion engine such that power generated by the internal combustion engine is transmitted to the winch by a non-mechanical connection;
a first electronic control unit, wherein the first electronic control unit is configured to control operation of components of the piece of equipment other than the winch; and
a second electronic control unit, wherein the second electronic control unit is independent of the first electronic control unit and configured to control operation of the winch.

2. The piece of equipment of claim 1 wherein the non-mechanical connection is a hydraulic connection.

3. The piece of equipment of claim 2 wherein the winch is powered by an open-loop hydraulic system.

4. The piece of equipment of claim 2 wherein the winch is powered by a closed-loop hydraulic system.

5. The piece of equipment of claim 1 wherein the non-mechanical connection is an electric connection.

6. The piece of equipment of claim 1 wherein the first electronic control unit is configured to control operation of at least one of: a steering component of the piece of equipment; an operative end-effector of the piece of equipment, a ripper, a movable boom, a movable blade, a grapple, a pipelayer drawworks, a wheel drive, a track drive, a swing drive, a chipper, a tiller, a grinder, a sweeper, a hoist, a capstan, and a fan.

7. The piece of equipment of claim 1 wherein the second electronic control unit includes a programmable logic controller.

8. A piece of heavy construction or forestry equipment, comprising:
a source of electrical power;
a winch coupled to the source of electrical power;
a first electronic control unit, wherein the first electronic control unit is configured to control operation of components of the piece of equipment other than the winch; and
a second electronic control unit, wherein the second electronic control unit is independent of the first electronic control unit and configured to control operation of the winch.

9. The piece of equipment of claim 8 wherein the first electronic control unit is configured to control operation of at least one of: a steering component of the piece of equipment; an operative end-effector of the piece of equipment, a ripper, a movable boom, a movable blade, a grapple, a pipelayer drawworks, a wheel drive, a track drive, a swing drive, a chipper, a tiller, a grinder, a sweeper, a hoist, a capstan, and a fan.

10. The piece of equipment of claim 8 wherein the second electronic control unit includes a programmable logic controller.

11. A method of operating a piece of heavy construction or forestry equipment, comprising:
running an internal combustion engine, thereby generating power from combustion of fuel;
transmitting power generated by the internal combustion engine to a winch by a non-mechanical connection;
controlling operation of components of the piece of heavy construction or forestry equipment other than the winch using a first electronic control unit; and
controlling operation of the winch using a second electronic control unit independent of the first electronic control unit.

12. The method of claim 11, further comprising:
storing information regarding operation of the winch in the second electronic control unit;
using the information stored in the second electronic control unit to detect an undesired condition of the operation of the winch; and
upon detecting the undesired condition of the operation of the winch, generating an alarm indicating the detection of the undesired condition.

13. The method of claim 11, further comprising:
storing information regarding operation of the winch in the second electronic control unit; and
using the information stored in the second electronic control unit to control operation of the winch.

14. The method of claim 11 wherein the internal combustion engine is a diesel engine and the fuel is diesel.

15. The method of claim 11 wherein the non-mechanical connection interrupts mechanical transmission of power from the internal combustion engine to the winch.

16. A method of operating a piece of heavy construction or forestry equipment, comprising:
transmitting electrical power from a source of electrical power to a winch;
controlling operation of components of the piece of heavy construction or forestry equipment other than the winch using a first electronic control unit; and
controlling operation of the winch using a second electronic control unit independent of the first electronic control unit.

17. The method of claim 16, further comprising:
storing information regarding operation of the winch in the second electronic control unit;
using the information stored in the second electronic control unit to detect an undesired condition of the operation of the winch; and
upon detecting the undesired condition of the operation of the winch, generating an alarm indicating the detection of the undesired condition.

18. The method of claim 16, further comprising:
storing information regarding operation of the winch in the second electronic control unit; and
using the information stored in the second electronic control unit to control operation of the winch.
